(19) United States
(12) Patent Application Publication
(10) Pub. No.: US 2013/0275546 A1
(43) Pub. Date: Oct. 17, 2013

(54) SYSTEMS AND METHODS FOR THE AUTOMATED MIGRATION FROM ENTERPRISE TO CLOUD STORAGE

(71) Applicant: Joseph SAIB, Santa Clara, CA (US)

(72) Inventor: Joseph SAIB, Santa Clara, CA (US)

(73) Assignee: AppSense, Inc., New York, NY (US)

(21) Appl. No.: 13/444,506

(22) Filed: Apr. 11, 2012

(51) Int. Cl. G06F 15/16

(52) U.S. Cl. 709/217

(57) ABSTRACT

Systems and methods are provided for the automated migration from enterprise to cloud storage. Each time that an enterprise receives an initial request for data from any enterprise user, the enterprise performs two operations. First, the enterprise retrieves the data from its physical storage media and provides the data to the user. Second, the enterprise automatically copies the requested data to a designated cloud storage. Upon receiving subsequent requests for the data from any enterprise user, the enterprise retrieves the data from the designated cloud storage and provides the data to the user.

### BACKGROUND

1. Technical Field

Disclosed systems and methods relate to the automated migration from enterprise to cloud storage.

2. Description of the Related Art

Traditionally, enterprises or businesses have physical storage media, such as storage servers, to store files associated with the enterprise. The physical storage media store files generated by an enterprise's users. A user can allow any user to access these files. Alternatively, a user can place restrictions on these files that allow only that user, or a specific subset of users, to access and/or modify these files. Depending on the size of the enterprise and/or the amount of files generated, an enterprise will have one or more physical storage media. The physical storage media can be located at the enterprise office or at a location remote from the enterprise office.

Enterprises set up their own networks to allow their users to access the files from the physical storage media. Users can access the files a number of different ways, from a number of different locations. While at the enterprise office, users can connect their work-issued desktop or mobile computers directly to the enterprise network via a wired or wireless connection. Through the computer, a user can access one or more files by selecting the “My Computer” icon on the desktop, selecting the associated network drive, selecting the relevant files and/or subfolders, and finally selecting the desired filenames. The user can also access one or more files using a document management system such as iManage and Worksite.

In addition, even when away from the enterprise office, users can also remotely connect their work-issued desktop or mobile computers to the enterprise network. Through the computer, a user can connect to the enterprise network via a wired or wireless connection using infrastructures such as a virtual private network (VPN) or Citrix. Once the user is connected to the enterprise network through one of these infrastructures, the user can access one or more files in the same way as if the user was in the enterprise office and was directly connected to the enterprise network.

In addition to, or alternative to, using a firm-issued computer, a user can use a personal desktop computer, a mobile computer, a tablet computer, and/or a cellular device to remotely connect to the enterprise network and access files from the physical storage media. Through the computer, a user can connect to the enterprise network via a wired or wireless connection using an infrastructure such as Citrix. Through the tablet computer and cellular device, the user can connect to the enterprise network via a wireless connection using an infrastructure such as MobileIron.

For enterprises, the use of physical storage media is extremely costly and takes up a lot of physical space. In addition, it takes time to access the files in the physical storage media, particularly for users who try to remotely access the physical storage media on their computers, tablet computers, and/or cellular devices.

With the advances in network communications, including the introduction of cloud computing, files can be stored in the cloud. Existing systems make it difficult for an enterprise to seamlessly migrate files from its physical storage media to the cloud storage. For example, existing systems typically require that an enterprise select all files or a subset of files to move to cloud storage. An enterprise's physical storage media typically contain a lot of files, many of which are likely old files that will rarely, infrequently, or never be accessed again. As a result, the cloud will end up storing many useless files.

Therefore, there is a need in the art to provide systems and methods for the automated migration from enterprise to cloud storage.

Accordingly, it is desirable to provide methods and systems that overcome these and other deficiencies of the related art.

### SUMMARY

In accordance with the disclosed subject matter, systems and methods are provided for the automated migration from enterprise to cloud storage.

Disclosed subject matter includes a non-transitory computer readable medium having executable instructions. The executable instructions are operable to cause an enterprise server to receive a request for data from a client device over a communication network and to determine whether the data is stored in a cloud or only in an enterprise physical storage medium. When the data is stored in the cloud, the executable instructions are then operable to cause the enterprise server to retrieve the data from the cloud and to send the data retrieved from the cloud to the client device over the communication network. When the data is stored only in the enterprise physical storage medium and not in the cloud, the executable instructions are then operable to cause the enterprise server to retrieve the data from the enterprise physical storage medium, to send the data retrieved from the enterprise physical storage medium to the client device over the communication network, and to automatically send the data to the cloud for storage.

The executable instructions are further operable to cause the enterprise server to determine an amount of remaining data that is stored in the enterprise physical storage medium but not stored in the cloud and to compare the amount of the remaining data to a threshold. When the amount of the remaining data is at or below the threshold, the executable instructions are then operable to cause the enterprise server to retrieve the remaining data from the enterprise physical storage medium and to send the remaining data retrieved from the enterprise physical storage medium to the cloud for storage.

Disclosed subject matter includes an enterprise apparatus comprising one or more interfaces configured to provide communication with a client via a communication network; and a processor, in communication with the one or more interfaces, and configured to run a module stored in memory. The module is configured to receive a request for data from a client device over a communication network and to determine whether the data is stored in a cloud or only in an enterprise physical storage medium. When the data is stored in the cloud, the module is configured to retrieve the data from the cloud and to send the data retrieved from the cloud to the client device over the communication network. When the data is stored only in the enterprise physical storage medium and not in the cloud, the module is configured to retrieve the data from the enterprise physical storage medium, to send the data retrieved from the enterprise physical storage medium to the client device over the communication network, and to automatically send the data to the cloud for storage.

The module is further configured to determine an amount of remaining data that is stored in the enterprise physical storage medium but not stored in the cloud and to compare the amount of the remaining data to a threshold. When the amount of the remaining data is at or below the threshold, the module is configured to retrieve the remaining data from the enterprise physical storage medium and to send the remaining data retrieved from the enterprise physical storage medium to the cloud for storage.

Disclosed subject matter includes a method comprising receiving a request for data from a client device over a communication network and determining whether the data is stored in a cloud or only in an enterprise physical storage medium. When the data is stored in the cloud, the method further comprises retrieving the data from the cloud and sending the data retrieved from the cloud to the client device over the communication network. When the data is stored only in the enterprise physical storage medium and not in the cloud, the method further comprises retrieving the data from the enterprise physical storage medium, sending the data retrieved from the enterprise physical storage medium to the client device over the communication network, and automatically sending the data to the cloud for storage.

The method further comprises determining an amount of remaining data that is stored in the enterprise physical storage medium but not stored in the cloud and comparing the amount of the remaining data to a threshold. When the amount of the remaining data is at or below the threshold, the method further comprises retrieving the remaining data from the enterprise physical storage medium and sending the remaining data retrieved from the enterprise physical storage medium to the cloud for storage.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

In this respect, before explaining at least one embodiment of the disclosed subject matter in detail, it is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be had to the accompanying drawings and descriptive matter in which there are illustrated preferred embodiments of the disclosed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates a diagram of a networked communication system in accordance with certain embodiments of the disclosed subject matter.

FIG. 2 illustrates a flow diagram illustrating how an enterprise provides for the automated migration of data to the cloud storage in accordance with certain embodiments of the disclosed subject matter.

FIG. 3 illustrates a flow diagram illustrating how the enterprise provides data to a user in accordance with certain embodiments of the disclosed subject matter.

FIG. 4 illustrates a block diagram of an enterprise server in accordance with certain embodiments of the disclosed subject matter.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the subject matter of the disclosed subject matter. In addition, it will be understood that the examples provided below are exemplary, and that it is contemplated that there are other systems and methods that are within the scope of the disclosed subject matter.

The disclosed subject matter relates to systems and methods for providing the automated migration from enterprise to cloud storage. An enterprise can seamlessly migrate to cloud storage by copying only requested data to the cloud and, upon receiving subsequent requests for the data, serving the data from the cloud. Each time that an enterprise receives an initial request for data from any enterprise user, the enterprise performs two operations. First, the enterprise retrieves the data from its physical storage media and provides the data to the user. Second, the enterprise automatically copies the requested data to a designated cloud storage.

The enterprise user can be any user or device authorized to request and receive the data. The authorized user can include an employee, consultant, independent contractor, and third-party service provider. In order to be able to access the enterprise network to request and receive data, the enterprise user may first have to enter log-in credentials, including a user name, password, key, and/or any other suitable information or combination of information. The data can be any suitable enterprise access data. For example, the data can be data files that include text, audio, video, images, or any other suitable data or combination of data. The initial data request can be made by the user from any suitable location on any suitable device. For example, the user can make the request while being directly connected to the enterprise network. Alternatively, the user can make the request while being remotely connected to the enterprise network. The user can make the request on a work-issued or personal device such as a desktop computer, a mobile computer, a tablet computer (e.g., iPad, Android-based tablet, Nook Tablet, Kindle Fire), and a cellular device (e.g., a smartphone such as a Blackberry, iPhone, Android-based smartphone). The designated cloud storage can any suitable cloud storage that stores the data with the same restrictions, security measures, authentication measures, policies, and other features associated with the enterprise and its physical storage media. The designated cloud storage can be hosted within and/or external to the enterprise.

In accordance with the disclosed subject matter, once the enterprise has copied the requested data to the designated cloud storage, upon receiving subsequent requests for the data from any enterprise user, the enterprise retrieves the data from the designated cloud storage and provides the data to the user. The subsequent data requests can be made by any user authorized to request and receive the data from any suitable location on any suitable device, similar to that described above. The retrieval of the data from the cloud storage is not limited to only the user who made the initial request for the data and/or the same device that was used to make the initial request for the data.

In accordance with the disclosed subject matter, over time, and as users request more data that is automatically migrated to the cloud storage, there may be a dropoff point at which the enterprise may decide to backup any remaining data to the designated cloud storage. The enterprise can set any suitable criteria or combination of criteria for determining the remaining data. For example, the remaining data can be any unused data that has not been requested by any user since the start of the migration process. As another example, the remaining data can be any unused data that has not been requested by any user since the start of the migration process, but that has been previously requested by the user on or after a specified date and/or time. In this embodiment, the enterprise can decide not to backup any old data that is unlikely to ever be accessed again by any user. In addition, the enterprise can set any suitable criteria or combination of criteria for the dropoff point. For example, the dropoff point can be a threshold based on the size of the remaining data (e.g., in bytes, Megabytes (MB), Gigabytes (GB)), the number of remaining data files, or a percentage of the data that is remaining. Once the enterprise backs-up any remaining data to the cloud storage, the enterprise may continue to use, or cease the use of, its physical storage media. Alternatively, the enterprise may decide to use its enterprise physical storage for only keeping copies of more recently generated and/or accessed data.

The disclosed subject matter provides advantages to enterprises and its users. Enterprises no longer require as much physical storage media. The use of cloud storage rather than physical storage media is significantly cheaper and requires much less physical space for enterprises. In addition, it is more convenient to provide enterprises with the automated migration from enterprise to cloud storage. This way, enterprises do not have to manually select which data to migrate or to decide to migrate all data. Furthermore, for enterprises users, accessing data from cloud storage rather than physical store media is more convenient and faster.

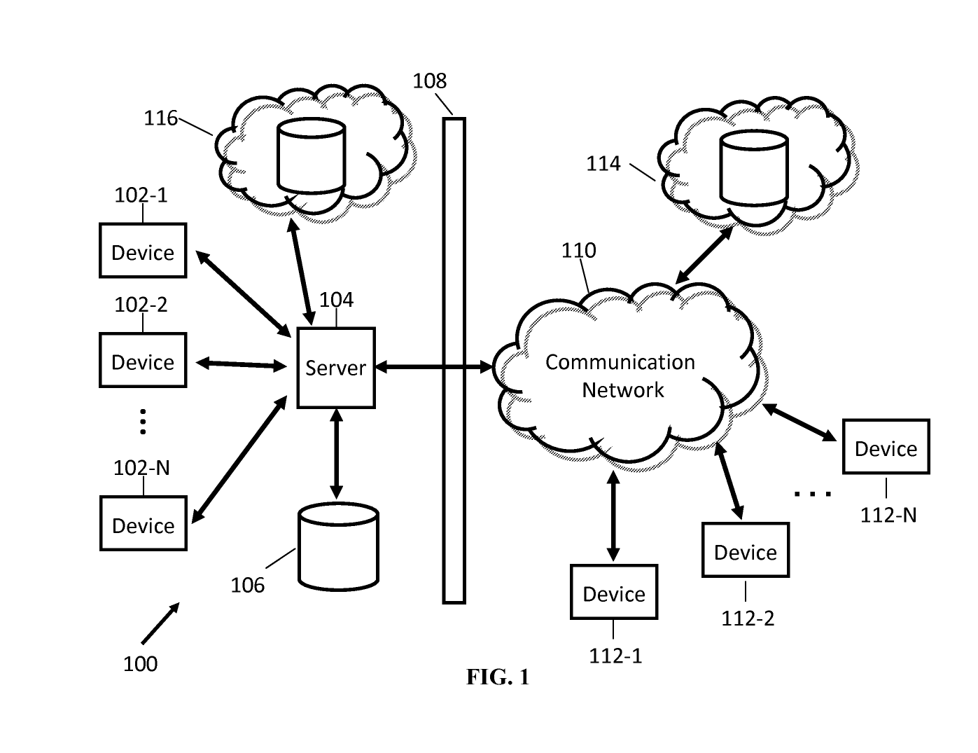

FIG. 1 illustrates a diagram of a networked communication system in accordance with an embodiment of the disclosed subject matter. FIG. 1 includes an enterprise 100, a communication network 110, a designated cloud storage 114, and at least one device 112 (e.g., device 112-1, 112-2, . . . 112-N).

The enterprise 100 includes at least one device 102 (e.g., device 102-1, 102-2, . . . 102-N), an enterprise server 104, at least one physical storage medium 106, a designated cloud storage 116, and a firewall 108. Each device 102 can be any suitable client device that allows any enterprise user to directly connect to the enterprise network. Each device 102 can include a desktop computer, a mobile computer, a tablet computer, a cellular device, or any other computing device having a processor and memory.

Each device 102 can communicate with the server 104 to send data to, and to receive data from, another device 102 and/or other network nodes (including device 112) across communication network 110. Although FIG. 1 shows each device 102 being directly coupled to the server 104, each device 102 can be connected to server 104 via any other suitable device, communication network, or combination thereof. For example, each device 102 can be coupled to the server 104 via one or more routers, switches, access points, and/or communication network (as described below in connection with communication network 110).

Server 104 is coupled to at least one physical storage medium 106, which stores the data for the enterprise 100. Any enterprise user, using any device 102 and 112, can store data in, and access data from, the physical storage medium 106 via server 104. FIG. 1 shows the server 104 and the physical storage medium 106 as separate components; however, the server 104 and physical storage medium 106 can be combined together. FIG. 1 also shows the server 104 as a single server; however, server 104 can include more than one server. FIG. 1 shows the physical storage medium 106 as a single physical storage medium; however, physical storage medium 106 can include more than one physical storage medium. The physical storage media can be located in the same physical location as the enterprise office, at the same physical location remote from the enterprise office, at different physical locations either at or remote from the enterprise office, or any other suitable location or combination of locations. The enterprise 100 can communicate with the communication network 110 via the firewall 108.

The communication network 110 can include the Internet, a cellular network, a telephone network, a computer network, a packet switching network, a line switching network, a local area network (LAN), a wide area network (WAN), a global area network, or any number of private networks currently referred to as an Intranet, and/or any other network or combination of networks that can accommodate data communication. Such networks may be implemented with any number of hardware and software components, transmission media and network protocols. FIG. 1 shows the network 110 as a single network; however, the network 110 can include multiple interconnected networks listed above.

FIG. 1 shows two embodiments of designated cloud storage 114 and 116. Cloud storage 114 is external to the enterprise 100 and coupled to the communication network 110. Cloud storage 116 is within the enterprise 100 and coupled to the server 104. Cloud storage 114 and/or 116 can be any suitable cloud storage for enterprise 100. Cloud storage 114 and/or 116 can store data from physical storage medium 106 with the same restrictions, security measures, authentication measures, policies, and other features associated with enterprise 100 and its physical storage medium 106. FIG. 1 shows the cloud storage 114 separate from the communication network 110; however, cloud storage 114 can be part of communication network 110 or another communication network. The enterprise 100 can use only cloud storage 114, only cloud storage 116, or both cloud storages 114 and 116. FIG. 1 shows one cloud storage 114 and one cloud storage 116; however, more than one cloud storage 114, more than one cloud storage 116, or any suitable combination thereof can be used.

Each device 112 can be any suitable client device that allows any enterprise user to remotely connect to the enterprise 100 via the communication network 110. Each device 112 can include a desktop computer, a mobile computer, a tablet computer, a cellular device, or any other computing device having a processor and memory. Each device 112 can remotely connect to the enterprise server 104 to send data to, and to receive data from, the physical storage medium 106 and the cloud storage 116. In addition, each device 112 can send data to, and receive data from, the cloud storage 114 over the communication network 110 either directly or via server 104.

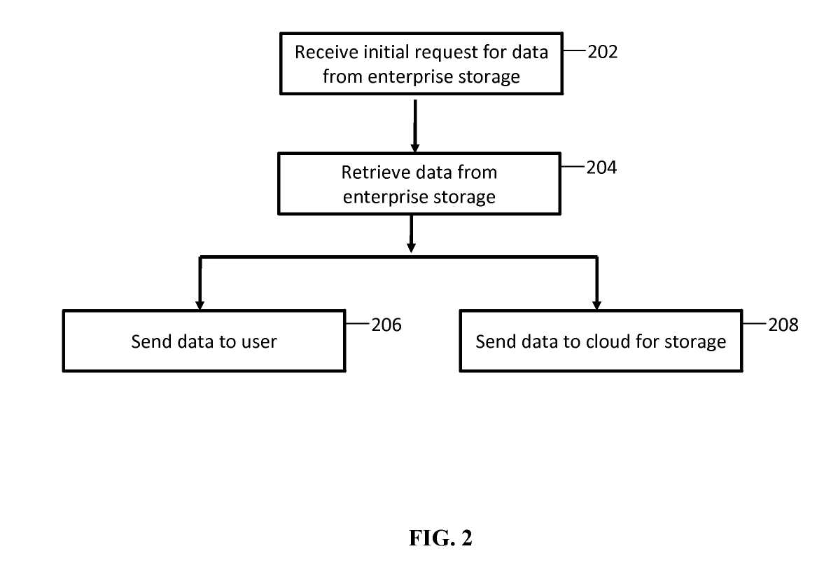

FIG. 2 illustrates a flow diagram illustrating how an enterprise 100 provides for the automated migration of data to the cloud storage in accordance with certain embodiments of the disclosed subject matter. At step 202, the server 104 receives an initial request for data from the physical storage medium 106. The request can be sent by any enterprise user from any of devices 102 and 112. At step 204, the server 104 retrieves the requested data from the physical storage medium 106. At step 206, the server 104 sends the requested data to the user at either device 102 or 112. At step 208, the server 104 sends the requested data to the cloud for storage (cloud storage 114 and/or 116). Although FIG. 2 shows steps 206 and 208 operating in parallel, steps 206 and 208 can operate serially in any suitable order.

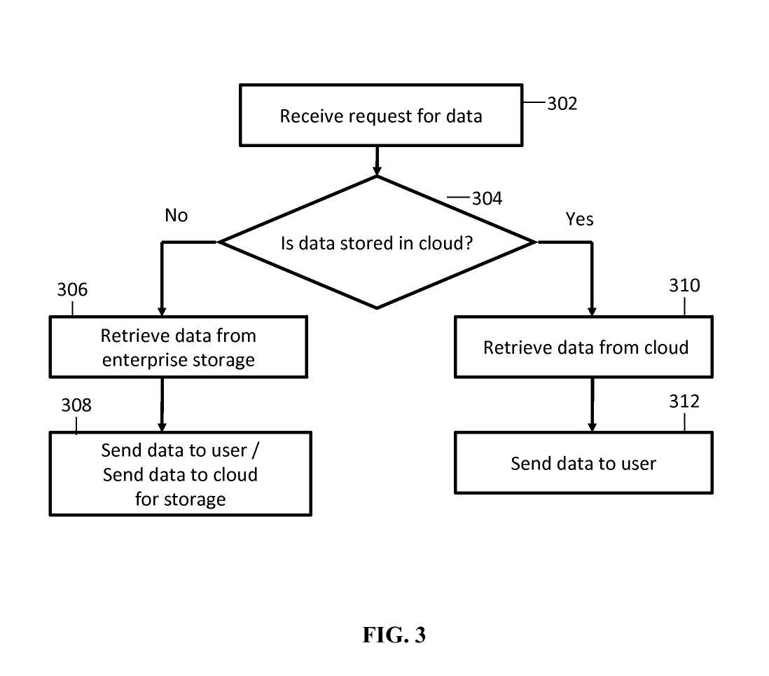

FIG. 3 illustrates a flow diagram illustrating how the enterprise 100 provides data to a user in accordance with certain embodiments of the disclosed subject matter. At step 302, the server 104 receives a request for data. The request can be sent by any enterprise user from any of devices 102 and 112. At step 304, the server 104 determines whether the requested data is stored in the cloud storage 114 and/or 116 or only in the physical storage medium 106.

If the requested data is not stored in the cloud storage 114 and/or 116 (i.e., the data is stored only in the physical storage medium 106), the server 104 retrieves the requested data from the physical storage medium 106 at step 306. Then at step 308, the server 104 provides the requested data to the user at either device 102 or 112 and also sends the requested data to the cloud for storage (cloud storage 114 and/or 116). Steps 306 and 308 are similar to steps 204 and 206/208 as shown and described in connection with FIG. 2.

If the requested data is stored in the cloud storage 114 and/or 116, the server 104 retrieves the requested data from the cloud storage 114 and/or 116 at step 310. Then at step 312, the server 104 provides the requested data to the user at either device 102 or 112. Although steps 310 and 312 as described as being performed by the server 104, in another embodiment the server 104 can request that the cloud storage 114 and/or 116 send the requested data directly to either device 102 or 112.

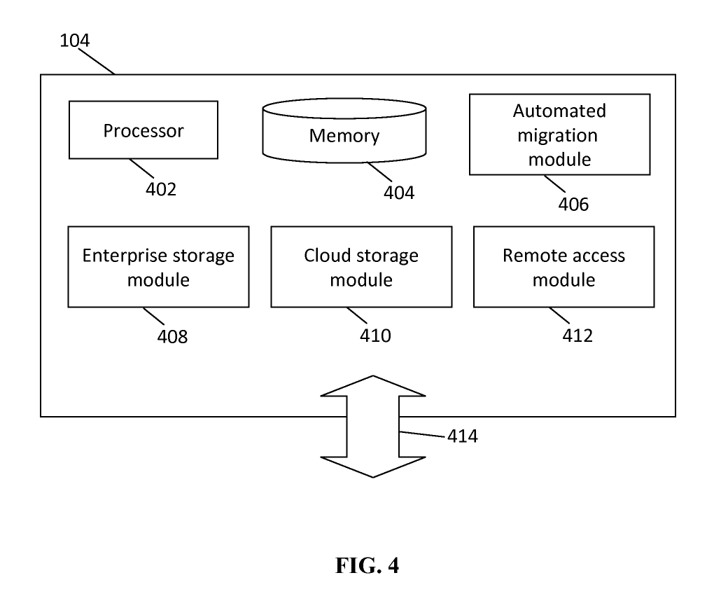

FIG. 4 illustrates a block diagram of an enterprise server 104 in accordance with certain embodiments of the disclosed subject matter. The server 104 can include at least a processor 402, at least one memory 404, an automated migration module 406, an enterprise storage module 408, a cloud storage module 410, and a remote access module 412.

An automated migration module 406 is configured to automatically migrate data from the physical storage medium 106 to the designated cloud storage 114 and/or 116. For example, the automated migration module 406 can be configured to perform the processing steps shown and described in connection with FIGS. 2 and 3. In addition, the automated migration module 406 can be configured to perform backup of any remaining data upon reaching a dropoff point. In one embodiment, the automated migration module 406 can use information from the enterprise storage module 408 and/or the cloud storage module 410 to determine whether the dropoff point has been reached.

The enterprise storage module 408 can be configured to store information associated with the data stored the physical storage medium 106. The enterprise storage module 408 can further be configured to allow any enterprise user at devices 102 and/or 112 to access data from the physical storage medium 106.

The cloud storage module 410 can be configured to store information associated with the data stored in the designated cloud storage 114. The cloud storage module 410 can further be configured to allow any enterprise user at device 102 and/or 112 to access data from the cloud storage 114 and/or 116.

The remote access module 412 can be configured to allow any enterprise user at device 112 to remotely connect to the enterprise network (enterprise 100) via any suitable infrastructure such as VPN or Citrix. The remote access module 412 can further be configured to allow any enterprise user at device 112 to access data from the physical storage medium 106 and/or the cloud storage 114 and/or 116.

The automated migration module 406, enterprise storage module 408, cloud storage module 410, and remote access module 412 can be implemented in software, which may be stored in memory 404. FIG. 4 shows an enterprise server 104 having separate modules 406, 408, 410, and 412 that perform the above-described operations in accordance with certain embodiments of the disclosed subject matter. In other embodiments of the invention, server 104 can include additional modules, less modules, or any other suitable combination of modules that perform any suitable operation or combination of operations. The memory 404 can be a non-transitory computer readable medium, flash memory, a magnetic disk drive, an optical drive, a programmable read-only memory (PROM), a read-only memory (ROM), or any other memory or combination of memories. The software runs on a processor 402 capable of executing computer instructions or computer code. The processor 402 might also be implemented in hardware using an application specific integrated circuit (ASIC), programmable logic array (PLA), field programmable gate array (FPGA), or any other integrated circuit.

An interface 414 provides an input and/or output mechanism to communicate internal to, and external to, the enterprise 100. The interface 414 enables communication with devices 102 within the enterprise 100, with external devices 112 over a communication network 110, and with the designated cloud storage 114 and/or 116. The interface 414 is implemented in hardware to send and receive signals in a variety of mediums, such as optical, copper, and wireless, and in a number of different protocols some of which may be non-transient.

The server 104 can be configured with one or more processors 402 that process instructions and run software that may be stored in the memory 404. The processor 402 also communicates with the memory and interfaces to communicate with other devices. The processor 402 can be any applicable processor such as a system-on-a-chip that combines a CPU, an application processor, and flash memory.

The server 104 can operate using an operating system (OS) software. In some embodiments, the OS software is based on a Linux software kernel and runs specific applications in the server such as monitoring tasks and providing protocol stacks. The OS software allows server resources to be allocated separately for control and data paths. For example, certain packet accelerator cards and packet services cards are dedicated to performing routing or security control functions, while other packet accelerator cards/packet services cards are dedicated to processing user session traffic. As network requirements change, hardware resources can be dynamically deployed to meet the requirements in some embodiments.

The server's software can be divided into a series of tasks that perform specific functions. These tasks communicate with each other as needed to share control and data information throughout the server 104. A task can be a software process that performs a specific function related to system control or session processing. Three types of tasks operate within the server 104 in some embodiments: critical tasks, controller tasks, and manager tasks. The critical tasks control functions that relate to the server's ability to process calls such as server initialization, error detection, and recovery tasks. The controller tasks can mask the distributed nature of the software from the user and perform tasks such as monitoring the state of subordinate manager(s), providing for intra-manager communication within the same subsystem, and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem is a software element that either performs a specific task or is a culmination of multiple other tasks. A single subsystem includes critical tasks, controller tasks, and manager tasks. Some of the subsystems that run on the server 104 include a system initiation task subsystem, a high availability task subsystem, a shared configuration task subsystem, and a resource management subsystem.

The system initiation task subsystem is responsible for starting a set of initial tasks at system startup and providing individual tasks as needed. The high availability task subsystem works in conjunction with the recovery control task subsystem to maintain the operational state of the server 104 by monitoring the various software and hardware components of the server 104. Recovery control task subsystem is responsible for executing a recovery action for failures that occur in the server 104 and receives recovery actions from the high availability task subsystem. Processing tasks are distributed into multiple instances running in parallel so if an unrecoverable software fault occurs, the entire processing capabilities for that task are not lost. User session processes can be sub-grouped into collections of sessions so that if a problem is encountered in one sub-group users in another sub-group will not be affected by that problem.

Shared configuration task subsystem can provide the server 104 with an ability to set, retrieve, and receive notification of server configuration parameter changes and is responsible for storing configuration data for the applications running within the server 104. A resource management subsystem is responsible for assigning resources (e.g., processor and memory capabilities) to tasks and for monitoring the task's use of the resources.

In some embodiments, the server 104 can reside in a data center and form a node in a cloud computing infrastructure. The server 104 can also provide services on demand. A module hosting a client is capable of migrating from one server to another server seamlessly, without causing program faults or system breakdown. The server 104 on the cloud can be managed using a management system.

The devices 102 and/or 112 can include user equipment of a cellular network. The user equipment communicates with one or more radio access networks and with wired communication networks. The user equipment can be a cellular phone having phonetic communication capabilities. The user equipment can also be a smart phone providing services such as word processing, web browsing, gaming, e-book capabilities, an operating system, and a full keyboard. The user equipment can also be a tablet computer providing network access and most of the services provided by a smart phone. The user equipment operates using an operating system such as Symbian OS, iPhone OS, RIM's Blackberry, Windows Mobile, Linux, HP WebOS, and Android. The screen might be a touch screen that is used to input data to the mobile device, in which case the screen can be used instead of the full keyboard. The user equipment can also keep global positioning coordinates, profile information, or other location information.

The device 102 or 112 also includes any platforms capable of computations and communication. Non-limiting examples can include televisions (TVs), video projectors, set-top boxes or set-top units, digital video recorders (DVR), computers, netbooks, laptops, and any other audio/visual equipment with computation capabilities.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A non-transitory computer readable medium having executable instructions operable to cause an enterprise server to:
receive a request for data from a client device over a communication network;
determine whether the data is stored in a cloud or only in an enterprise physical storage medium;
when the data is stored in the cloud:
retrieve the data from the cloud, and
send the data retrieved from the cloud to the client device over the communication network; and
when the data is stored only in the enterprise physical storage medium:
retrieve the data from the enterprise physical storage medium,
send the data retrieved from the enterprise physical storage medium to the client device over the communication network, and
automatically send the data to the cloud for storage.

2. The computer-readable medium of claim 1, further comprising executable instructions operable to cause the enterprise server to communicate with the client device over the communication network within an enterprise.

3. The computer-readable medium of claim 1, further comprising executable instructions operable to cause the enterprise server to communicate with the client device over the communication network remote from an enterprise.

4. The computer-readable medium of claim 1, further comprising executable instructions operable to cause the enterprise server to receive authorization information from the client device before receiving the request for the data from the client device.

5. The computer-readable medium of claim 1, further comprising executable instructions operable to cause the enterprise server to:
receive a second request for the data from a second client device over the communication network;
retrieve the data from the cloud; and
send the data retrieved from the cloud to the second client device over the communication network.

6. The computer-readable medium of claim 1, further comprising executable instructions operable to cause the enterprise server to:
determine an amount of remaining data that is stored in the enterprise physical storage medium but not stored in the cloud;
compare the amount of the remaining data to a threshold; and
when the amount of the remaining data is at or below the threshold:
retrieve the remaining data from the enterprise physical storage medium, and
send the remaining data retrieved from the enterprise physical storage medium to the cloud for storage.

7. The computer-readable medium of claim 6, furthering comprising executable instructions operable to cause the enterprise server to compare the amount of the remaining data to the threshold based on one of a number of bytes of the remaining data, a number of files of the remaining data, and a percentage of the remaining data.

8. An enterprise apparatus comprising:
one or more interfaces configured to provide communication with a client device via a communication network; and
a processor, in communication with the one or more interfaces, and configured to run a module stored in memory that is configured:
to receive a request for data from a client device over a communication network,
to determine whether the data is stored in a cloud or only in an enterprise physical storage medium,
when the data is stored in the cloud:
to retrieve the data from the cloud, and
to send the data retrieved from the cloud to the client device over the communication network, and
when the data is stored only in the enterprise physical storage medium:
to retrieve the data from the enterprise physical storage medium,
to send the data retrieved from the enterprise physical storage medium to the client device over the communication network, and
to automatically send the data to the cloud for storage.

9. The apparatus of claim 8, wherein the module is further configured to communicate with the client device over the communication network within an enterprise.

10. The apparatus of claim 8, wherein the module is further configured to communicate with the client device over the communication network remote from an enterprise.

11. The apparatus of claim 8, wherein the module is further configured to receive authorization information from the client device before receiving the request for the data from the client device.

12. The apparatus of claim 8, wherein the module is further configured to:
receive a second request for the data from a second client device over the communication network;
retrieve the data from the cloud; and
send the data retrieved from the cloud to the second client device over the communication network.

13. The apparatus of claim 8, wherein the module is further configured to:
determine an amount of remaining data that is stored in the enterprise physical storage medium but not stored in the cloud;
compare the amount of the remaining data to a threshold; and
when the amount of the remaining data is at or below the threshold:
retrieve the remaining data from the enterprise physical storage medium, and
send the remaining data retrieved from the enterprise physical storage medium to the cloud for storage.

14. The apparatus of claim 13, wherein the module is further configured to, furthering comprising executable instructions operable to cause the enterprise server to compare the amount of the remaining data to the threshold based on one of a number of bytes of the remaining data, a number of files of the remaining data, and a percentage of the remaining data.

15. A method comprising:
receiving a request for data from a client device over a communication network;
determining whether the data is stored in a cloud or only in an enterprise physical storage medium;
when the data is stored in the cloud:
retrieving the data from the cloud, and
sending the data retrieved from the cloud to the client device over the communication network; and
when the data is stored only in the enterprise physical storage medium:
retrieving the data from the enterprise physical storage medium,
sending the data retrieved from the enterprise physical storage medium to the client device over the communication network, and
automatically sending the data to the cloud for storage.

16. The method of claim 15, further comprising receiving authorization information from the client device before receiving the request for the data from the client device.

17. The method of claim 15, further comprising:
receiving a second request for the data from a second client device over the communication network;
retrieving the data from the cloud; and
sending the data retrieved from the cloud to the second client device over the communication network.

18. The method of claim 17, further comprising receiving the second request for the data from the second client device different from the client device.

19. The method of claim 15, further comprising:
determining an amount of remaining data that is stored in the enterprise physical storage medium but not stored in the cloud;
comparing the amount of the remaining data to a threshold; and
when the amount of the remaining data is at or below the threshold:
retrieving the remaining data from the enterprise physical storage medium, and
sending the remaining data retrieved from the enterprise physical storage medium to the cloud for storage.

20. The method of claim 19, wherein the threshold is based on one of a number of bytes of the remaining data, a number of files of the remaining data, and a percentage of the remaining data.
